(19) United States
(12) Patent Application Publication
(10) Pub. No.: US 2015/0284624 A1
(43) Pub. Date: Oct. 8, 2015

(54) METHOD OF STABILIZING VISCOSIFYING POLYMERS IN WELL TREATMENT FLUID

(71) Applicant: Baker Hughes Incorporated, Houston, TX (US)

(72) Inventors: Leiming Li, Sugar Land, TX (US); Qi Qu, Spring, TX (US); Hong Sun, Houston, TX (US); Jia Zhou, The Woodlands, TX (US); Paul S. Carman, Spring, TX (US); Ahmed M. Gomaa, Tomball, TX (US); Michael P. Mehle, Thornton, CO (US)

(21) Appl. No.: 14/243,668

(22) Filed: Apr. 2, 2014

(51) Int. Cl. C09K 8/68; E21B 43/26; C09K 8/60

(52) U.S. Cl. CPC C09K 8/685; C09K 8/60; E21B 43/26

(57) ABSTRACT

Productivity from a subterranean formation is enhanced by pumping into a well penetrating the formation after the well has been drilled a hard water aqueous fluid containing a polymeric stabilizer and a crosslinkable viscosifying polymer such as carboxymethyl guar or carboxymethyl cellulose.

### FIELD OF THE DISCLOSURE

The disclosure relates to a method of stabilizing viscosifying polymers in well treatment fluids prepared with hard water.

### BACKGROUND OF THE DISCLOSURE

Aqueous well treatment fluids typically contain a crosslinkable viscosifying polymer in order to carry particulates into a subterranean formation penetrated by a well. Polysaccharides are often preferred for use as viscosifying polymers. Suitable polysaccharides include galactomannan gums [such as guar gum and guar gum like carboxymethyl guar (CMG), carboxymethyhydroxypropyl guar (CMHPG) and hydroxypropyl guar (HPG)], and to a lesser extent, cellulose derivatives such as hydroxyethyl cellulose (HEC) or carboxymethylhydroxyethyl cellulose (CMHEC). CMG is generally more preferred over CMHPG and HPG because lower loadings of polymer may be used.

Typically, aqueous well treatment fluids are prepared using the water source which is available at the wellsite. Where the aqueous well treatment fluid is prepared off site, tap water is typically used. Often, the water used in preparation of well treatment fluid contains in excess of 100 ppm of divalent cations, such as calcium and/or magnesium, and is considered to be hard water.

Viscosifying polymers are typically crosslinked with metallic crosslinking agents, such as those containing Ti, and/or Zr. With CMG, divalent cations in hard water compete with the metal of the crosslinking agent. This results in less viscous fluids. At downhole temperatures around 200° F., the viscosity of CMG containing fluids breaks. As such, when well treatment fluids are prepared from hard water, the viscosifying polymer is more typically HPG or CMHPG. This increases the costs of the wellbore operation.

Thus, there is a need for a method of mitigating the undesirable effects caused from divalent cations in hard water used to prepare well treatment fluids, especially for those well treatment fluids prepared from galactomannan gum derivatives.

It should be understood that the above-described discussion is provided for illustrative purposes only and is not intended to limit the scope or subject matter of the appended claims or those of any related patent application or patent. Thus, none of the appended claims or claims of any related application or patent should be limited by the above discussion or construed to address, include or exclude each or any of the above-cited features or disadvantages merely because of the mention thereof herein.

### SUMMARY OF THE DISCLOSURE

In an embodiment, the disclosure relates to a method of enhancing productivity from a subterranean formation penetrated by a well wherein an aqueous fluid containing a crosslinkable viscosifying polymer is pumped into the well after the well has been drilled. The aqueous fluid contains a metallic crosslinking agent and a polymeric stabilizer. The aqueous fluid is prepared with hard water (the concentration of divalent cations, mainly calcium and magnesium cations, in the water being in excess of 100 ppm). The polymeric stabilizer exhibits greater bonding affinity for the divalent cations than the crosslinkable viscosifying polymer.

In another embodiment, a method of enhancing productivity from a well treatment operation is disclosed wherein a fluid comprising water having divalent cations in excess of 100 ppm, a crosslinkable viscosifying polymer, a metal containing crosslinking agent and a polymeric stabilizer is pumped into the well. The polymeric stabilizer may be an alginate, pectin, carboxymethyl cellulose, xanthan, a polyacrylamide or a salt or ester thereof, a derivatized polyacrylamide or a salt or ester thereof, a partially hydrolyzed polyacrylamide or a salt or ester thereof, an acrylamidomethylpropane sulfonic acid polymer or copolymer or a salt or ester thereof, scleroglucan or konjac as well as mixtures thereof.

In another embodiment of the disclosure, a method of fracturing a subterranean formation penetrated by a well is provided wherein a fluid comprising water having divalent cations in excess of 100 ppm, a crosslinkable viscosifying polymer and a polymeric stabilizer is pumped into the well at a pressure sufficient to create or enlarge a fracture. The polymeric stabilizer may be an alginate, pectin, carboxymethyl cellulose, xanthan, a polyacrylamide or a salt ester thereof, a derivatized polyacrylamide or a salt or ester thereof, a partially hydrolyzed polyacrylamide or a salt or ester thereof, an acrylamidomethylpropane sulfonic acid polymer or copolymer or a salt or ester thereof, scleroglucan or konjac as well as mixtures thereof.

In another embodiment of the disclosure, a sand control operation is provided wherein a fluid comprising water having divalent cations in excess of 100 ppm, a crosslinkable viscosifying polymer, and a polymeric stabilizer is pumped into a well. The polymeric stabilizer may be an alginate, pectin, carboxymethyl cellulose, xanthan, a polyacrylamide or a salt ester thereof, a derivatized polyacrylamide or a salt or ester thereof, a partially hydrolyzed polyacrylamide or a salt or ester thereof, an acrylamidomethylpropane sulfonic acid polymer or copolymer or a salt or ester thereof, scleroglucan or konjac as well as mixtures thereof.

In another embodiment of the disclosure, a method of enhancing the productivity of hydrocarbons from a subterranean formation is provided wherein a fluid comprising water having divalent cations in excess of 100 ppm, carboxymethyl guar and a polymeric stabilizer is pumped into a well.

Accordingly, the present disclosure includes features and advantages which enhance the productivity of hydrocarbons from a well. Characteristics and advantages of the present disclosure described above and additional features and benefits will be readily apparent to those skilled in the art upon consideration of the following detailed description of various embodiments and referring to the accompanying drawings.

### BRIEF DESCRIPTION OF THE DRAWINGS

The following figures are part of the present specification, included to demonstrate certain aspects of various embodiments of this disclosure and referenced in the detailed description herein:

FIG. 1 compares the viscosity of a carboxymethyl guar (CMG) containing fracturing fluid having calcium cations with and without sodium alginate.

FIG. 2 demonstrates the viscosity of a carboxymethyl guar containing fracturing fluid having calcium cations with pectin.

FIG. 3 demonstrates the viscosity of a carboxymethyl guar containing fracturing fluid having calcium cations with derivatized polyacrylamide.

FIG. 4 demonstrates the viscosity of a carboxymethyl guar containing fracturing fluid having calcium cations with sodium carboxymethyl cellulose.

FIG. 5 compares the viscosity of a carboxymethyl guar containing fracturing fluid having calcium and magnesium cations prepared with field water with and without sodium alginate.

FIG. 6 demonstrates the viscosity of a carboxymethyl guar containing fracturing fluid having calcium cations with scleroglucan.

FIG. 7 demonstrates the viscosity of a carboxymethyl guar containing fracturing fluid having calcium cations with konjac.

### DETAILED DESCRIPTION OF THE PREFERRED EMBODIMENTS

Characteristics and advantages of the present disclosure and additional features and benefits will be readily apparent to those skilled in the art upon consideration of the following detailed description of exemplary embodiments of the present disclosure and referring to the accompanying figures. It should be understood that the description herein and appended drawings, being of example embodiments, are not intended to limit the claims of this patent or any patent or patent application claiming priority hereto. On the contrary, the intention is to cover all modifications, equivalents and alternatives falling within the spirit and scope of the claims. Changes may be made to the particular embodiments and details disclosed herein without departing from such spirit and scope.

As used herein and throughout various portions (and headings) of this patent application, the terms “disclosure”, “present disclosure” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference.

This document does not intend to distinguish between components that differ in name but not function. Also, the terms “including” and “comprising” are used herein and in the appended claims in an open-ended fashion, and thus should be interpreted to mean “including, but not limited to . . . . ” Further, reference herein and in the appended claims to components in a singular tense does not necessarily limit the present disclosure or appended claims to only one such component or aspect, but should be interpreted generally to mean one or more, as may be suitable and desirable in each particular instance.

The use of a polymeric stabilizer enables use of aqueous fluids produced from hard water in well treatment operations wherein the aqueous fluid further contains a viscosifying polymer. The term “hard water” as used herein refers to water having a high mineral content such as having greater than 100 ppm of divalent cations like magnesium and calcium. More typically, the amount of divalent cations in the water source is in excess of 200 ppm.

It has been found that aqueous well treatment fluids prepared from hard water and containing a viscosifying polymer may be stabilized by including in the fluid a polymeric stabilizer. While not being bound by any particular theory, it is believed that the polymeric stabilizer binds the divalent cation(s) in the hard water and thus prevents the divalent cation(s) from binding to and adversely affecting the viscosifying polymer.

In an embodiment, the polymeric stabilizer is an alginate. Alginates are polysaccharides typically isolated from brown algae, such as kelp, or seaweed and contain monomeric units of alpha-L-gluronic acid (G unit) and beta-D mannuronic acid (M unit). The alginate is preferably an alginate salt such as sodium alginate or potassium alginate, more preferably sodium alginate. Alternatively, the alginate can be used in the acid form.

In another embodiment, the polymeric stabilizer is a pectin. Pectin is a structural heteropolysaccharide contained in the primary cell walls of terrestrial plants. It is produced commercially as a white to light brown powder, mainly extracted from citrus fruits, and is used in food as a gelling agent. Pectins are rich in galacturonic acid. In nature, around 80 percent of carboxyl groups of galacturonic acid in pectin are esterified with methanol.

In an embodiment, the polymeric stabilizer may have repeating units of the functional group —CONH₂. Such polymeric stabilizers include polyacrylamides having repeating free acrylamide units. Polyacrylamides may include copolymers having such free acrylamide units as well as units, such as an acrylic acid moiety or an ester or salt thereof, which may be derived from the acrylamide unit(s). Polyacrylamides may also include partially hydrolyzed polyacrylamides as well as copolymers (including partially hydrolyzed copolymers) of acrylamide such as acrylamide/2-acrylamido-2-methylpropane sulfonate (AMPS) copolymers and copolymers of acrylamide and alkylacrylamides (such as copolymers with ethylene, propylene and/or styrene). Salts of AMPS may further be used. Partially hydrolyzed polyacrylamides (PHPAs) are acrylamide polymers having at least 1%, but not 100%, of the acrylamide groups in the form of carboxylate groups. As used herein, “salt” includes ammonium and alkali and alkaline earth metal salts. Ester, as used herein, shall include alkyl esters, such as C₁-C₆ alkyl esters as well as hydroxylated C₁-C₆ alkyl esters.

In an embodiment, the weight average molecular weight of the polymeric stabilizer may be from under about 1,000 to above about 1,000,000.

In an embodiment, the polymeric stabilizer may be a carboxyalkyl cellulose, such as carboxymethyl cellulose. Carboxymethyl cellulose is a cellulose derivative with carboxymethyl groups (—CH2-COOH) bound to some of the hydroxyl groups of the glucopyranose monomers that make up the cellulose backbone. It may also be used as its sodium salt, i.e., sodium carboxymethyl cellulose.

In another embodiment, the polymeric stabilizer may be scleroglucan, a natural polysaccharide produced by fermentation of the filamentous fungus Sclerotium rolfsii.

In still another embodiment, the polymeric stabilizer may be konjac. Konjac is a polysaccharide extracted from the plant of the genus Amorphophallus.

The polymeric stabilizer may further be xanthan gum, a polysaccharide secreted by the bacterium Xanthomonas campestris.

The viscosifying polymer may be a hydratable polymer such as, for example, one or more polysaccharides capable of forming crosslinked gels. These include galactomannan gums, guars, derivatized guars, cellulose derivatives, starch, starch derivatives, xanthan, derivatized xanthan and salts thereof (such as sodium and potassium salts) as well as mixtures thereof. Suitable derivatives include carboxylated derivatives including carboxyalkyl derivatives like carboxymethyl derivatives. The viscosifying polymer may further be a water hydratable synthetic polymer, such as polyacrylamide or copolymer contain polyacrylamide or polyacrylic acid as well as carboxylated derivatives thereof including carboxyalkyl derivatives like carboxymethyl derivatives. The carboxyalkyl group may be bound to the backbone of the polymer or the side chain of the polymer or a combination thereof.

Specific examples include, but are not limited to, guar gum, guar gum derivative, locust bean gum, welan gum, karaya gum, xanthan gum, scleroglucan, diutan, cellulose and cellulose derivatives, etc. More typical polymers or gelling agents include guar gum, hydroxypropyl guar (HPG), carboxymethyl guar (CMG), hydroxyethyl guar (HEG), hydroxybutyl guar (HBG), carboxymethyl hydroxypropyl guar (CMHPG), hydroxyethyl cellulose (HEC), carboxymethyl hydroxyethyl cellulose (CMHEC), carboxymethyl cellulose (CMC), dialkyl carboxymethyl cellulose, and salts thereof, etc.

Typically, the amount of viscosifying polymer in the aqueous well treatment fluid is between from about 10 to about 50, preferably from about 10 to about 30, pounds per 1,000 gallons of water. Preferably, a low loading of the polymer (typically between from about 0.1 to about 0.6% by weight) is desired in order to minimize polymer residue and conductivity damage.

Certain viscosifying polymers, when formulated with hard water, are especially unstable. For instance, CMG, when formulated with hard water, typically breaks at temperatures less than 200° F. Thus, such fluids and hard water are not properly effective when exposed to downhole temperatures in excess of 200° F. and are broken by the time downhole temperatures are around 250° F. The disclosure therefore especially relates to such unstable polymers.

In a particularly preferred embodiment of the disclosure, the viscosifying polymer of the fluid is a carboxylated guar (such as CMG and CMHPG) and the polymer concentration in the fluid is greater than the C* concentration for the polymer. The C* concentration is described as that concentration necessary to cause polymer chain overlap. Suitable polymer chain overlap to effectively obtain a crosslinked gel is thought to occur when polymer concentration exceeds the C* concentration. Exemplary of such carboxylated guar fluids are disclosed in U.S. Pat. No. 7,012,044, herein incorporated by reference. Often fluids containing such polymers in hard water suffer great loss in fluid viscosity. For instance, 200 ppm of calcium ions in hard water could nearly totally eliminate the fluid viscosity. With the inclusion of any of the additives disclosed herein, the viscosity of such aqueous fluids in hard water could be match or almost matched as aqueous fluids containing the same polymers in soft water (or water with much lower concentrations of calcium and/or magnesium ions).

The viscosifying polymers are crosslinkable in order to withstand the high temperature conditions commonly found in deeper oil and gas wells with little reduction in viscosity. Any crosslinking agent suitable for crosslinking the viscosifying polymer may be employed. Examples of suitable crosslinking agents include metal containing crosslinking agents such as those containing metal ions of aluminum or transition metals like antimony, zirconium and titanium such as Zr (IV) and Ti (IV). Such crosslinking agents may be organometallics or organic complexed metal ion crosslinking agents.

Suitable crosslinking agents include zirconium lactate, zirconium lactate triethanolamine, zirconium carbonate, zirconium acetylacetonate, zirconium diisopropylamine lactate, titanium ammonium lactate, titanium triethanolamine and titanium acetylacetonate. Zr (IV) and Ti (IV) may further be added directly as ions or oxy ions into the fluid. Other examples of suitable crosslinkers may also be found in U.S. Pat. No. 5,201,370; U.S. Pat. No. 5,514,309, U.S. Pat. No. 5,247,995, U.S. Pat. No. 5,562,160, and U.S. Pat. No. 6,110,875, incorporated herein by reference.

The crosslinking agent may optionally be encapsulated.

Typically, the crosslinking agent is employed in the treatment fluid in a concentration of from about 0.001 percent to about 2 percent, preferably from about 0.005 percent to about 1.5 percent, and, most preferably, from about 0.01 percent to about 1.0 percent.

The fluid may also be buffered to a desired pH range by use of conventional buffering agents such as potassium carbonate or mixtures of potassium carbonate and potassium hydroxide for high pH and mixtures of sodium acetate and acetic acid for low pH. The optimum pH range for high pH fluid is often from about 8.5 to 11.5, most preferably from about 9.0 to 10.5 and for low pH fluid is often from about 3.5 to 5.5, most preferably from about 4.5 to 5.

The fluid disclosed herein may further include a carbonates (including carbonates of alkali or alkaline earth metals), a bicarbonate (including a bicarbonate of an alkali metal), an alkoxylated sorbitol (including ethoxylated and propoxylated and mixtures thereof), a high temperature stabilizer such as sodium thiosulfate and/or phenothiazine, as well as a mixture thereof. When present, such components may be present in an amount up to 10 percent by weight of the fluid.

The fluid may further contain particulates for sand control or proppants for fracturing.

Suitable particulates include glass or ceramic beads, walnut shell fragments, aluminum pellets or needles, nylon pellets, resin-coated sand, synthetic organic particles, glass microspheres, sintered bauxite, mixtures thereof and the like.

In a preferred embodiment, the proppant is a relatively lightweight or substantially neutrally buoyant particulate material or a mixture thereof. Such proppants may be chipped, ground, crushed, or otherwise processed. By “relatively lightweight” it is meant that the proppant has an apparent specific gravity (ASG) that is substantially less than a conventional proppant employed in hydraulic fracturing operations, e.g., sand or having an ASG similar to these materials. Especially preferred are those proppants having an ASG less than or equal to 3.25. Even more preferred are ultra lightweight proppants having an ASG less than or equal to 2.25, more preferably less than or equal to 2.0, even more preferably less than or equal to 1.75, most preferably less than or equal to 1.25 and often less than or equal to 1.05.

The proppant may further be a resin coated ceramic proppant or a synthetic organic particle such as nylon pellets, ceramics. Suitable proppants further include those set forth in U.S. Patent Publication No. 2007/0209795 and U.S. Patent Publication No. 2007/0209794, herein incorporated by reference. The proppant may further be a plastic or a plastic composite such as a thermoplastic or thermoplastic composite or a resin or an aggregate containing a binder.

By “substantially neutrally buoyant”, it is meant that the proppant has an ASG close to the ASG of an ungelled or weakly gelled carrier fluid (e.g., ungelled or weakly gelled completion brine, other aqueous-based fluid, or other suitable fluid) to allow pumping and satisfactory placement of the proppant using the selected carrier fluid. For example, urethane resin-coated ground walnut hulls having an ASG of from about 1.25 to about 1.35 may be employed as a substantially neutrally buoyant proppant particulate in completion brine having an ASG of about 1.2. As used herein, a “weakly gelled” carrier fluid is a carrier fluid having minimum sufficient polymer, viscosifier or friction reducer to achieve friction reduction when pumped down hole (e.g., when pumped down tubing, work string, casing, coiled tubing, drill pipe, etc.), and/or may be characterized as having a polymer or viscosifier concentration of from greater than about 0 pounds of polymer per thousand gallons of base fluid to about 10 pounds of polymer per thousand gallons of base fluid, and/or as having a viscosity of from about 1 to about 10 centipoises. An ungelled carrier fluid may be characterized as containing about 0 pounds per thousand gallons of polymer per thousand gallons of base fluid. (If the ungelled carrier fluid is slickwater with a friction reducer, which is typically a polyacrylamide, there is technically 1 to as much as 8 pounds per thousand of polymer, but such minute concentrations of polyacrylamide do not impart sufficient viscosity (typically <3 cP) to be of benefit).

Other suitable relatively lightweight proppants are those particulates disclosed in U.S. Pat. Nos. 6,364,018, 6,330,916 and 6,059,034, all of which are herein incorporated by reference. These may be exemplified by ground or crushed shells of nuts (pecan, almond, ivory nut, brazil nut, macadamia nut, etc); ground or crushed seed shells (including fruit pits) of seeds of fruits such as plum, peach, cherry, apricot, etc.; ground or crushed seed shells of other plants such as maize (e.g. corn cobs or corn kernels), etc.; processed wood materials such as those derived from woods such as oak, hickory, walnut, poplar, mahogany, etc. including such woods that have been processed by grinding, chipping, or other form of particalization. Preferred are ground or crushed walnut shell materials coated with a resin to substantially protect and water proof the shell. Such materials may have an ASG of from about 1.25 to about 1.35.

Further, the relatively lightweight particulate for use in the invention may be a selectively configured porous particulate, as set forth, illustrated and defined in U.S. Pat. No. 7,426,961, herein incorporated by reference.

The well treatment fluid may further contain conventional additives such as breakers, crosslinking delay agents, surfactants, biocides, surface tension reducing agents, scale inhibitors, gas hydrate inhibitors, clay stabilizers, foaming agents, demulsifiers as well as mixtures thereof.

The well treated herein may include oil wells, gas wells, coal bed methane wells and geothermal wells.

When used in hydraulic fracturing, the aqueous well treatment fluid may be injected into a subterranean formation in conjunction with a hydraulic fracturing treatment or other treatment at pressures sufficiently high enough to cause the formation or enlargement of fractures.

Other well treating applications may be near wellbore in nature (affecting near wellbore regions) and may be directed toward improving wellbore productivity and/or controlling the production of fracture proppant or formation sand. Particular examples include gravel packing and “frac-packs.” Moreover, such particles may be employed alone as a fracture proppant/sand control particulate, or in mixtures in amounts and with types of fracture proppant/sand control materials, such as conventional fracture or sand control particulate.

In one exemplary embodiment, a gravel pack operation may be carried out on a wellbore that penetrates a subterranean formation to prevent or substantially reduce the production of formation particles into the wellbore from the formation during production of formation fluids. The subterranean formation may be completed so as to be in communication with the interior of the wellbore by any suitable method known in the art, for example by perforations in a cased wellbore, and/or by an open hole section. A screen assembly such as is known in the art may be placed or otherwise disposed within the wellbore so that at least a portion of the screen assembly is disposed adjacent the subterranean formation. A slurry including the well treatment composites and a carrier fluid may then be introduced into the wellbore and placed adjacent the subterranean formation by circulation or other suitable method so as to form a fluid-permeable pack in an annular area between the exterior of the screen and the interior of the wellbore that is capable of reducing or substantially preventing the passage of formation particles from the subterranean formation into the wellbore during production of fluids from the formation, while at the same time allowing passage of formation fluids from the subterranean formation through the screen into the wellbore.

As an alternative to use of a screen, the sand control method may use the well treatment composites in accordance with any method in which a pack of particulate material is formed within a wellbore that it is permeable to fluids produced from a wellbore, such as oil, gas, or water, but that substantially prevents or reduces production of formation materials, such as formation sand, from the formation into the wellbore. Such methods may or may not employ a gravel pack screen, may be introduced into a wellbore at pressures below, at or above the fracturing pressure of the formation, such as frac pack, and/or may be employed in conjunction with resins such as sand consolidation resins is so desired.

In addition to hydraulic fracturing and sand control, the aqueous well treatment may be used as a scale inhibitor to prevent the formation and/or deposition of scales formed from divalent metals.

All percentages set forth in the Examples are given in terms of weight units except as may otherwise be indicated.

### EXAMPLES

### Example 1

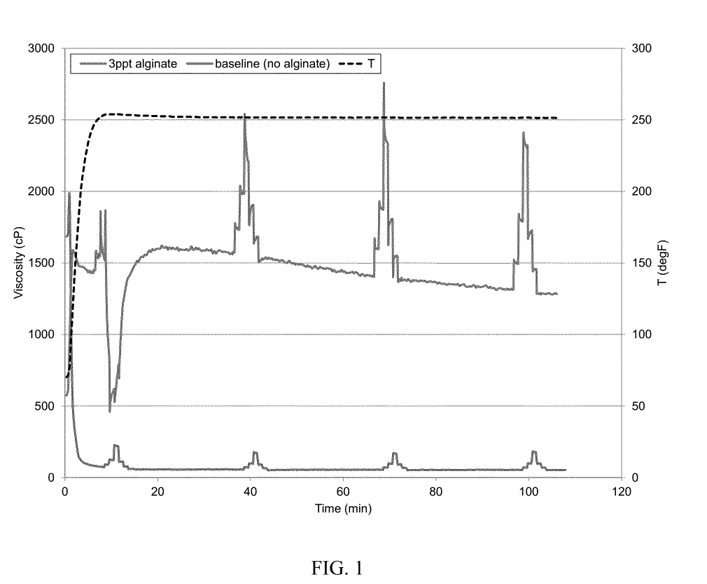

An aqueous baseline fluid was prepared with deionized water, 200 parts per million (ppm) calcium cations (in the form of calcium chloride), 30 pounds per thousand gallons (30 ppt; 1 ppt equals to about 0.12 g/L) carboxymethyl guar (CMG), 0.3 gallons per thousand gallons (0.3 gpt; 1 gpt equals to 1 mL/L) of a potassium buffer, 1 gpt sodium thiosulfate solution as high-temperature stabilizer, and 1.1 gpt zirconium crosslinker. CMG was allowed to fully hydrate in water. The pH of the gel was about 10.2 at room temperature. The viscosity at 250° F. was measured with a Chandler 5550 viscometer, following the API RP 39 schedule. The results are shown in FIG. 1. The fluid viscosity quickly dropped to about 60 cP at 14 minutes and to about 50 cP at 44 minutes, indicating the damage caused from the calcium cations in water. The baseline was the same for the following other examples unless otherwise indicated.

To show that alginate could mitigate hard water damage, a second fluid was made identical to the aqueous baseline fluid but further containing 3 ppt (0.36 g/L added) powdered sodium alginate (CAS: 9005-38-3). The CMG and sodium alginate were hydrated together. The polymers were allowed to fully hydrate in water. The pH of the gel was about 10.2 at room temperature. The viscosity was similarly measured and is illustrated in FIG. 1. The fluid viscosity was higher than that of the baseline fluid and stayed above 1200 cP at about 2 hours (the trough at the first ramp peak might have been due to bob climbing). This indicates that the sodium alginate had greatly mitigated the fluid damage caused by the calcium ions.

### Example 2

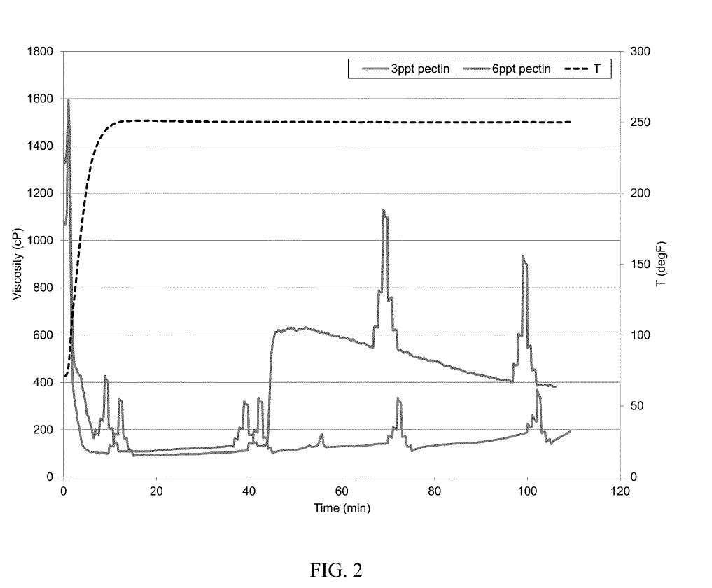

The baseline was the same as that in Example 1. The baseline was prepared with deionized water, 200 ppm calcium cations, 30 ppt CMG, 0.3 gpt potassium buffer, 1 gpt sodium thiosulfate solution, and 1.1 gpt zirconium crosslinker. The viscosity at 250° F. was similarly measured with a Chandler 5550 viscometer. The baseline fluid viscosity dropped to about 60 cP at 14 minutes and to about 50 cP at 44 minutes. To show that pectin could mitigate hard water damage, two fluids were made identical to the baseline fluid but further containing 3 ppt and 6 ppt, respectively, powdered pectin (CAS: 9000-69-5). The CMG and pectin were hydrated together. The polymers were allowed to fully hydrate in water. The pH of the gel was about 10.2 at room temperature. The viscosity was similarly measured and is illustrated in FIG. 2. The addition of 3 ppt of the pectin enhanced the viscosity by about 100% or more when compared with the baseline, while the addition of 6 ppt of the pectin enhanced the viscosity to a peak value of over 600 cP. In both cases, the enhancement by the pectin showed some delay, possibly due to the fact that around 80 percent of carboxyl groups of galacturonic acid in the pectin were esterified with methanol.

### Example 3

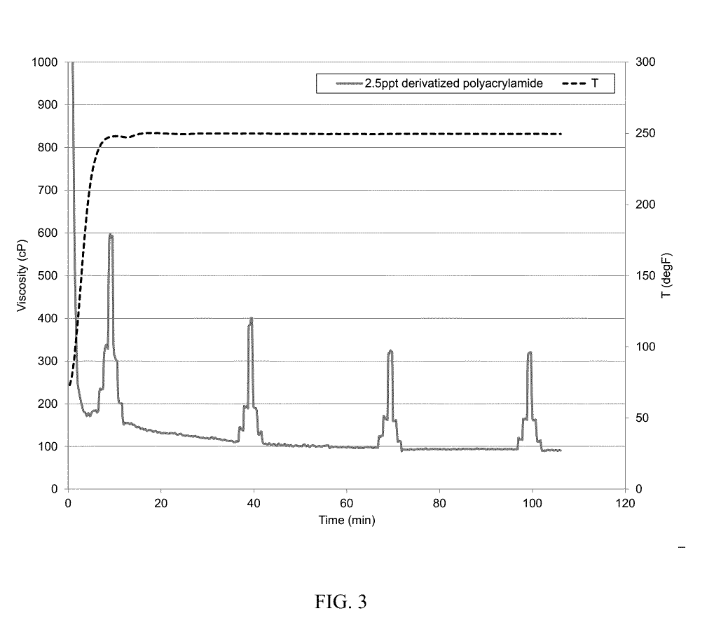

The baseline was the same as that in Example 1. The baseline was prepared with deionized water, 200 ppm calcium cations, 30 ppt CMG, 0.3 gpt potassium buffer, 1 gpt sodium thiosulfate solution, and 1.1 gpt zirconium crosslinker. The viscosity at 250° F. was similarly measured. The baseline fluid viscosity dropped to about 60 cP at 14 minutes and to about 50 cP at 44 minutes. To show that the derivatized polyacrylamide could mitigate hard water damage, a fluid identical was made to the baseline fluid but further containing about 2.5 ppt derivatized polyacrylamide (the AMPS polyacrylamide, with 20% AMPS). The CMG and polyacrylamide were hydrated together. The polymers were allowed to fully hydrate in water. The pH of the gel was about 10.3 at room temperature. The viscosity was similarly measured and is illustrated in FIG. 3. The addition of 2.5 ppt of derivatized polyacrylamide enhanced the viscosity by about 100% or more when compared with the baseline.

### Example 4

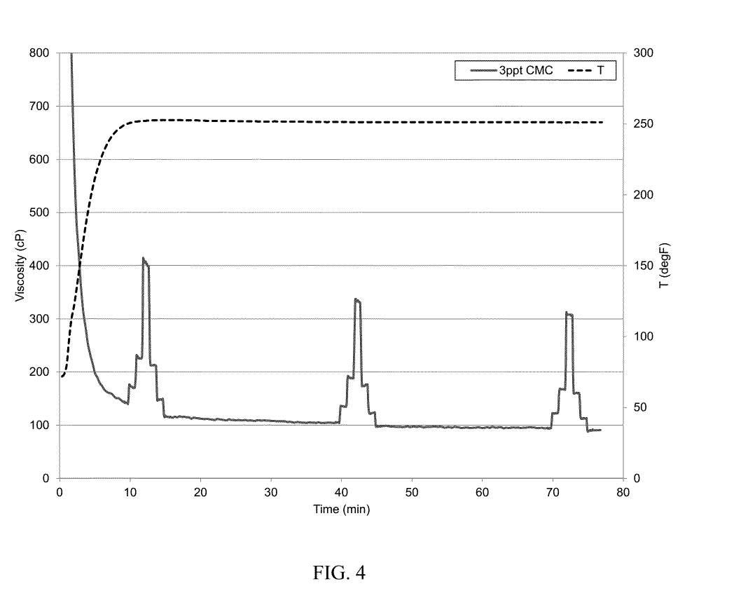

The baseline was similar to that in Example 1. To show that sodium carboxymethyl cellulose (CMC) could mitigate hard water damage, a fluid was made identical to the baseline fluid but further containing 3 ppt sodium CMC. The CMG and sodium CMC were hydrated together. The polymers were allowed to fully hydrate in water. The pH of the gel was about 10.2 at room temperature. The viscosity was similarly measured and is illustrated in FIG. 4. The addition of 3 ppt of sodium CMC enhanced the viscosity by about 100% when compared with the baseline.

### Example 5

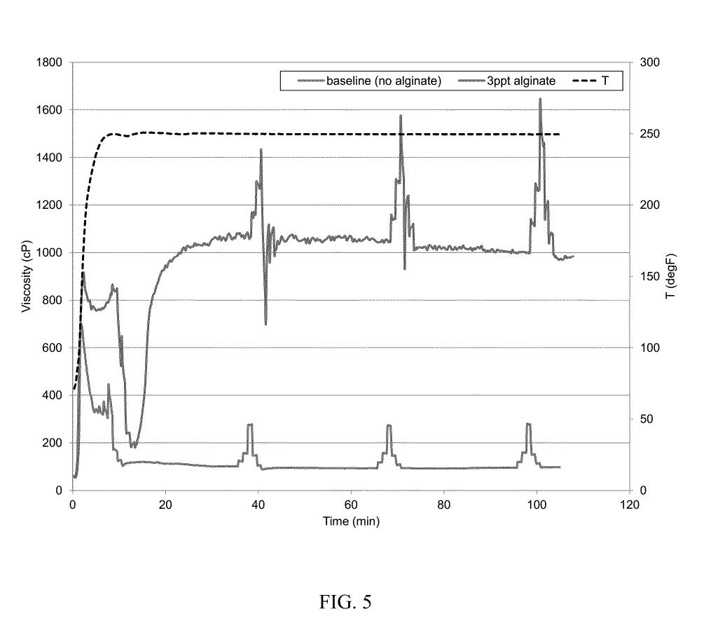

A field water sample was used in this example. The water contained about 225 mg/L calcium cations and about 109 mg/L magnesium cations. The baseline was prepared with field water, 30 ppt CMG, 5 ppt sodium bicarbonate, 0.6 gpt potassium buffer, 1 gpt sodium thiosulfate solution, and 1.1 gpt zirconium crosslinker. The pH of the gel was about 9.3 at room temperature. The viscosity at 250° F. was similarly measured and shown in FIG. 5. To show that the sodium alginate could mitigate hard water damage, a fluid was made identical to the baseline fluid but further containing 3 ppt sodium alginate. The CMG and alginate were hydrated together. The polymers were allowed to fully hydrate in water. The pH of the gel was about 9.3 at room temperature. The viscosity was similarly measured and is illustrated in FIG. 5. The addition of 3 ppt of the sodium alginate enhanced the viscosity by about 10 times when compared with the baseline (the trough at the first ramp peak might have been due to bob climbing). In other tests, when sodium bicarbonate was replaced with 0.5 gpt of an alkoxylated sorbitol, the addition of 3 ppt of the sodium alginate enhanced the viscosity by several times when compared with the baseline.

### Example 6

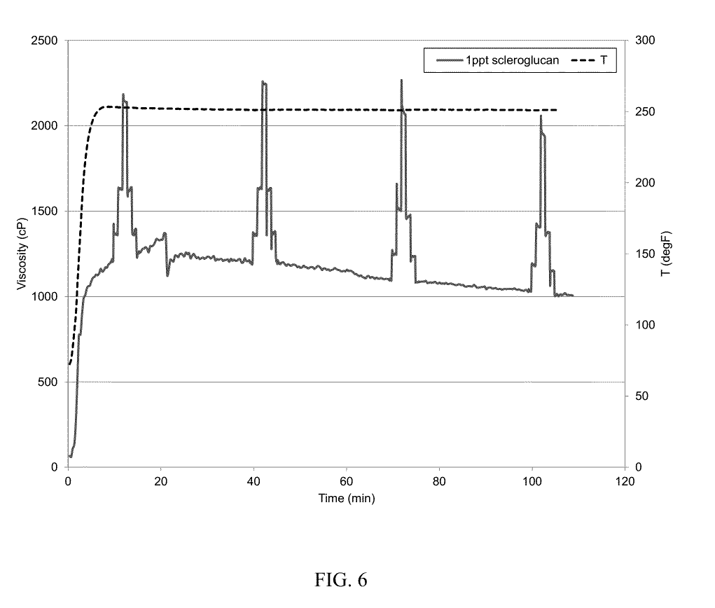

The baseline was similar to that in Example 1. To show that scleroglucan could mitigate the damage by hard water, a second fluid was made identical to the aqueous baseline fluid except that the fluid also contained 1 ppt scleroglucan. The CMG and scleroglucan were hydrated together. The polymers were allowed to fully hydrate in water. The gel pH was about 10.1 at room temperature. The viscosity was similarly measured and is illustrated in FIG. 6. The viscosity of the fluid containing scleroglucan was much higher than that of the baseline fluid and stayed above 1000 cP for the whole period indicating that the scleroglucan had greatly mitigated the damage caused by the calcium ions.

### Example 7

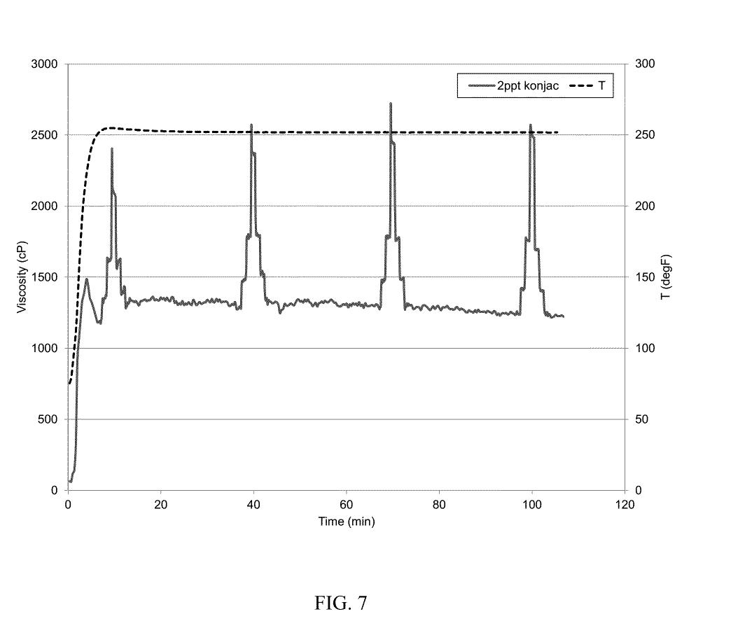

The baseline was similar to that in Example 1. To show that konjac could mitigate the damage by hard water, a second fluid was made identical to the baseline fluid except that the fluid also contained 2 ppt konjac. The CMG and konjac were hydrated together. The polymers were allowed to fully hydrate in water. The gel pH was about 10.1 at room temperature. The viscosity was measured similarly and is illustrated in FIG. 7. As indicated, the fluid showed viscosity staying above 1200 cP for the whole period indicating that konjac had greatly mitigated the damage caused by the calcium cations in water.

While exemplary embodiments of the disclosure have been shown and described, many variations, modifications and/or changes in the components are possible, contemplated by the patent applicant(s), within the scope of the appended claims, and may be made and used by one of ordinary skill in the art without departing from the spirit or teachings of the invention and scope of appended claims. Thus, all matter herein set forth or shown in the accompanying drawings should be interpreted as illustrative, and the scope of the disclosure and the appended claims should not be limited to the embodiments described and shown herein.

What is claimed is:

1. A method of enhancing productivity from a subterranean formation penetrated by a well comprising pumping into the well after completion of a drilling operation a fluid comprising:
(a) water comprising divalent cations in excess of 100 ppm;
(b) a crosslinkable viscosifying polymer;
(c) a metallic crosslinking agent; and
(d) a polymeric stabilizer having greater bonding affinity for the divalent cations than the crosslinkable viscosifying polymer.

2. The method of claim 1, wherein the divalent cations comprise calcium and magnesium and further wherein the concentration of divalent cations in the water is greater than or equal to 200 ppm.

3. The method of claim 1, wherein the crosslinkable viscosifying polymer is a polysaccharide.

4. The method of claim 3, wherein the polysaccharide is a galactomannan gum, a galactomannan derivative or a cellulosic derivative.

5. The method of claim 4, wherein the polysaccharide is a carboxylated guar derivative or carboxylated cellulosic derivative or a mixture thereof.

6. The method of claim 4, wherein the galactomannan gum is selected from the group consisting of guar, carboxymethyl guar, carboxymethylhydroxypropyl guar and hydroxproyl guar and mixtures thereof.

7. The method of claim 5, wherein the polysaccharide is selected from the group consisting of carboxymethyl guar, carboxymethyl hydroxypropyl guar, carboxymethyl cellulose, carboxymethyl hydroxyethyl cellulose dialkyl carboxymethyl cellulose and mixtures thereof.

8. The method of claim 1, wherein the polymeric stabilizer contains repeat units having free carboxylic acid, carboxylic acid salts, carboxylic acid ester groups, free amido groups or a mixture thereof.

9. The method of claim 1, wherein the amount of polymeric stabilizer in the fluid is about 20% or less the amount of the crosslinkable viscosifying polymer.

10. The method of claim 8, where the polymeric stabilizer is selected from the group consisting of alginate, pectin, carboxymethyl cellulose, xanthan and salts and/or esters thereof.

11. The method of claim 8, where the polymeric stabilizer is selected from the group consisting of polyacrylamides, derivatized polyacrylamides, partially hydrolyzed polyacrylamides, acrylamidomethylpropane sulfonic acid polymer or copolymer or a salt or ester thereof and mixtures thereof.

12. The method of claim 1, wherein the polymeric stabilizer is selected from scleroglucan and konjac.

13. The method of claim 1, wherein the fluid further comprises a member selected from the group consisting of carbonates, bicarbonates, an alkoxylated sorbitol and a mixture thereof.

14. The method of claim 1, wherein the fluid further comprises a high temperature stabilizer selected from the group consisting of sodium thiosulfate, phenothiazine and a mixture thereof.

15. A method of enhancing productivity from a well treatment operation comprising pumping into a well a fluid comprising:
(a) water having at divalent cations in excess of 100 ppm;
(b) a crosslinkable viscosifying polymer;
(c) a crosslinking agent comprising a metal; and
(d) a polymeric stabilizer selected from the group consisting of alginates, pectin, carboxymethyl cellulose, xanthan, polyacrylamides and salts and/or esters thereof, derivatized polyacrylamides and salts and/or esters thereof, partially hydrolyzed polyacrylamides and salts and/or esters thereof, acrylamidomethylpropane sulfonic acid polymer or copolymer and salts and/or esters thereof, scleroglucan and konjac and mixtures thereof.

16. The method of claim 15, wherein the well treatment operation is hydraulic fracturing.

17. The method of claim 15, wherein the well treatment operation is a sand control operation.

18. The method of claim 15, wherein the divalent cations comprise calcium and magnesium and further wherein the concentration of divalent cations in the water is greater than or equal to 200 ppm.

19. The method of claim 15, wherein the crosslinkable viscosifying polymer is a galactomannan gum.

20. The method of claim 19, wherein the galactomannan gum is selected from the group consisting of guar, carboxymethyl guar, carboxymethylhydroxypropyl guar and hydroxproyl guar and mixtures thereof.

21. The method of claim 20, wherein the galactomannan gum is carboxymethyl guar.

22. The method of claim 15, wherein the polymeric stabilizer is an alginate.

23. The method of claim 15, wherein the polymeric stabilizer is scleroglucan.

24. The method of claim 15, wherein the polymeric stabilizer is konjac.

25. A method of fracturing a subterranean formation penetrated by a well which comprises pumping into the well at a pressure sufficient to create or enlarge a fracture a fluid comprising:
(a) water having divalent cations in excess of 100 ppm;
(b) a crosslinkable viscosifying polymer; and
(c) a polymeric stabilizer selected from the group consisting of alginates, pectin, carboxymethyl cellulose, xanthan, polyacrylamides and salts and/or esters thereof, derivatized polyacrylamides and salts and/or esters thereof, partially hydrolyzed polyacrylamides and salts and/or esters thereof, acrylamidomethylpropane sulfonic acid polymer or copolymer and salts and/or esters thereof, scleroglucan and konjac and mixtures thereof.

26. The method of claim 25, wherein the crosslinkable viscosifying polymer is carboxymethyl guar.
